(19) United States
(12) Patent Application Publication
(10) Pub. No.: US 2005/0284931 A1
(43) Pub. Date: Dec. 29, 2005

(54) Digital transaction recorder with facility access control

(75) Inventors: John Adams, Essex Fells, NJ (US); Alex Adams, Essex Fells, NJ (US); Robert Caputo, Bridge Water, NJ (US)

Correspondence Address: STEPHEN B. ACKERMAN, 28 DAVIS AVENUE, POUGHKEEPSIE, NY, 12603, US

(73) Assignee: Regiscope Digital Imaging Co. LLC

(21) Appl. No.: 11/213,211

(22) Filed: Aug. 26, 2005

Related U.S. Application Data
(63) Continuation of application No. 10/238,705, filed on Sep. 10, 2002.

(51) Int. Cl. G06K 5/00; G06K 7/10

(52) U.S. Cl. 235/382; 235/380; 235/377

(57) ABSTRACT

A digital transaction recorder system coupled to a database is used to create an identification badge, to permit access to an area of a facility, and to produce a database record, of the access to a facility by an individual. Digital images are captured of an individual and the individual's identification document, which are stored in a database record along with personal data and a scan of any document being transported by the individual. The system creates a badge that permits access to the facility being visited by the individual. Remote badge readers coupled to the database allow access to areas of the facility depending upon the authorization stored in the individual's database record. Each access to the facility is time and date recorded in the database record. Access to the database record is by personal data (name) or a bar code on the badge.

### RELATED PATENT APPLICATION

This application is related to U.S. patent application Ser. No. ______ docket number REG 02-001, Ser. No. 10/238,705, filed on Sep. 10, 2002, and assigned to the same assignee as the present invention, and which is herein incorporated by reference in its entirety.

### BACKGROUND OF THE INVENTION

1. Field of Invention

The present invention relates to security control, and in particular security control of a facility using a Linux-based digital transaction recorder system.

2. Description of Related Art

In the increasing need for facility security a number of security control systems have been established such as Trans Tech System's Visitor Management (www.ttsys.com/visitor_mgmt.html) using STOPware's Passage Point software (www.stopware.com/). These security control systems provide a means by which a visitor to a facility can be logged in and logged out maintaining a record of a visit. The ability to manage access to a facility can be crucial to business wellbeing by providing a record of who has visited at what date and where in the facility an individual had access. In order to provide this information a security control system needs to be installed. This can be an expensive undertaking, but as an added feature to an already installed document transaction recorder, the increased cost of providing the added apparatus, methodology and software can be mitigated.

U.S. Pat. No. 6,749,112 (Terada et al.) is directed to a visitor pass system, method and program to minimize and expedite visitor formalities comprising a visitor terminal, server and staff terminals. U.S. Pat. No. 6,801,907 (Zagami) is directed to a process, apparatus, computer system, software and peripheral equipment for capturing one or more persons and related documents and providing a database record. U.S. Pat. No. 6,794,986 (Pucheck et al.) is directed to an automated access control apparatus and method to determine if a person should be granted access to an area.

### SUMMARY OF THE INVENTION

It is an objective of the present invention to use a digital transaction recording system to produce a database record and a badge from which the badge allows access to an area of a facility depending upon the database record.

It is also an objective of the present invention to record a transaction by copying and storing a document, or a set of documents, transported by an individual.

It is further an objective of the present invention to produce a badge to be used by the individual to gain access to an area of a facility permitted by the authorization stored in the database record of the individual, which is updated to the access control panel.

It is still further an objective of the present invention to record a time and date record of the access to the facility into the database record of the individual.

It is also an objective of the present invention to access the database record of an individual by using a bar code, or a magnetic stripe, on an access badge or by personal data such as the name of the individual.

A digital transaction recording system related to U.S. patent application Ser. No. 10/238,705 filed Sep. 10, 2002 is adapted to provide access of an individual to a facility and/or an area within the facility. A database capability is coupled to the digital transaction recording system to store a record of an individual, comprising a picture of the individual, an image of one or more identification documents of the individual and personal data, which can include amongst other data, name, address, telephone number, Social Security number, affiliation and emergency contact.

The digital transaction recording system produces a badge associated with a database record of the individual that comprises the form of a key tag with a unique bar code or a magnetic stripe, a permanent badge with a color picture of the individual, the name of the individual and a unique bar code or magnetic stripe, or a visitor stick-on badge containing a picture of the individual, the name of the individual and a unique bar code. The key tag is used for returning visitors, i.e. vendors, to identify a previously established data base record for an individual. The key tag is used at a visitor reception area to facilitate and expedite the creation of a temporary stick-on badge for the returning visitor. The key tag does not provide entrance to a facility but allows the temporary stick-on badge to be created, which in turn is read by a guard scanning the bar code to allow entrance by the visitor to the facility. The permanent badge is for individuals that require frequent daily access to a facility, i.e. employees, and is read by a badge reader wherein the bar code is scanned or the magnetic stripe is swiped through a slot in the reader.

Another form of a permanent badge is an RFID (radio frequency identification) card. The RFID card contains a semiconductor chip coupled to an antenna. Contained within the semiconductor chip is the identification information that is necessary to identify the individual to the system for entrance to a facility. The RFID cards are detected by RF signals transmitted by RF units at the entrance to the facility where the transmitted RF signals can be active over short distances of inches or over larger distances measured in feet depending upon the requirements of the facility. The RFID card can have the physical form of a permanent badge (credit card size) or can be of a size and shape of a key tag. In either case the security system recognizes and treats the RFID card as a permanent badge regardless of the physical shape.

Remote badge readers coupled to the database are used to scan the bar code on the permanent badges or allow the magnetic stripe to be swiped in the badge reader. The individual is allowed or denied access to an area of a facility depending upon the authorization stored in the database record of the individual. When the badge reader accesses the individual's database record for authorization to permit access, a date and time is recorded into the individual's database record along with the area of a facility to which access is being requested.

### BRIEF DESCRIPTION OF THE DRAWINGS

This invention will be described with reference to the accompanying drawings, wherein:

FIG. 1 is a system diagram of the present invention;

FIG. 2 is a diagram of the present invention showing coupling of a plurality of badge readers to the system database;

FIG. 3 is a method of the present invention for managing security of a facility; and

FIG. 4 is a method of the present invention for use of an ID scanner during sign-in of an individual at a facility.

### DETAILED DESCRIPTION OF THE PREFERRED EMBODIMENT

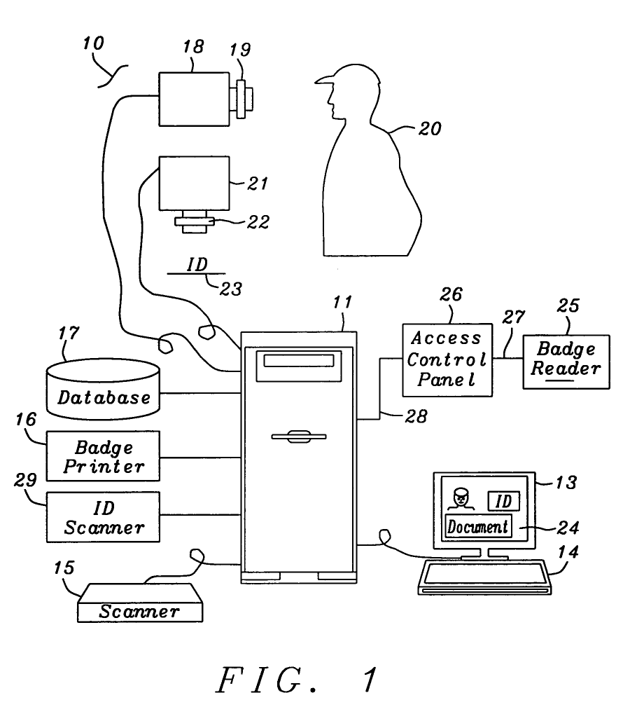

In FIG. 1 is shown a system diagram of the present invention. The system 10 comprises a controller 11, which can be a computer with the appropriate software to allow the required operations. Coupled to the controller 11 is a display screen 13 for viewing images and records being entered into the system, a keyboard 14 for data entry and a scanner 15 to produce an image of a document being transported by an individual 20 such as a bill of lading. A first digital camera 18 with flexible positioning is coupled to the controller 11 to provide a picture image of the individual 20. A second digital camera 21 is coupled to the controller 11 and is fixed into position with respect to a holder 23, which contains identification (ID) of the individual 20.

Once the individual 20 is positioned properly in front of the first digital camera 18 and an ID is placed in the holder 23 a couple of simple key strokes on the keyboard 14 allows the system to capture an image of the individual 20 and the individual's ID and present the images on the display screen 24. Additional keystrokes allow the capture of the document transported by the individual 20 by activating the scanner 15. Personal data of one or more items representing the individual 20 is entered into the controller 11 using the keyboard 14 comprising name, address, telephone number, drivers license, Social Security number, affiliation and emergency contact number. In addition an authorization for access to part of a facility or all the facility is entered into the controller 11.

An ID scanner 29 coupled to the controller 11 is used to verify the validity of an identification card presented by the individual 20. The ID scanner 29 reads a bar code on the card to verify the validity of the card and capture information pertaining to the individual presenting the card that fills in data fields related to the individual that are stored in the database. The bar code on the identification card is either a one dimensional bar code (1-D) or a two dimensional bar code (2-D). Some ID cards contain a magnetic stripe that can also be scanned to determine the validity of the ID card and capture information for the record stored in the database 17. The bar code, or the magnetic stripe, contains information of the individual 20 such as name, address and other information that is visually available on the surface of the identification card, and when automatically capture from an ID card, it reduces tha amount of manual entry of data into the database record of the individual. If the bar code, or magnetic stripe, is found to provide an invalid match of visual information on the card or is invalid for any reason, authorization is denied and the database 17 in updated accordingly.

Upon sign in to a facility the ID of the individual 20 is scanned and the database 17 is searched for a matching record. If a matching record is found, the record is presented to the individual 20 and the individual signs in. If there is not a matching record in the database, the option to establish a database record can be taken by the operator of digital transaction recorder and facility access control system 10 of the present invention. It should be noted that the ID scanner, whereas a facilitating element, is an optional unit, and the manual data entry can be used to provide facility access control.

Once the authorization and personal data has been entered into the system along with the images of the individual 20, the individual's ID, and the document transported by the individual, the authorization, personal data and images are stored into a record, or file, in the database 17, which is identified by one or more elements of the personal data. If the individual 20 requires a badge to allow entry into a facility or an area of a facility, a badge is printed using the badge printer 16 coupled to the controller 11. The badge comprises one or more forms, a key tag containing a barcode or magnetic stripe, a permanent badge containing a picture of the individual, the individual's name and a barcode or magnetic stripe; or a temporary stick-on badge containing a picture of the individual, the individual's name and a barcode. The barcode and the magnetic stripe links the badge to the individuals file stored in the database 17 along with the individual's name printed on the badge.

A badge reader 25 is coupled to an access control panel 26 by a wire connection or a wireless connection 27, and the access control panel is coupled to the controller 11 by a connection that is a wire or wireless connection 28. The access control panel controls the badge readers 25, and information is uploaded and downloaded to the access control panel from the database 17, keeping the information in the access control panel up-to-date with that in the database. If the controller 11 is not active, the badge readers will continue to operate properly since access data is stored in the access control panel.

When an individual 20 with a badge desires access to an area of a facility, the individual submits his/her badge to the badge reader 25. The badge reader reads the barcode, or a magnetic stripe, on the badge and queries the access control panel 26 for permission to allow entrance of the individual to the area of the facility. For a temporary stick-on badge and a key tag a guard reads the stick-on badge or the key tag with a bar code scanner, which in turn queries the database 17 for permission to allow entrance of the individual to the area of the facility. Each time an individual enters or leaves an area of a facility, a date and time is recorded into the database file of the individual.

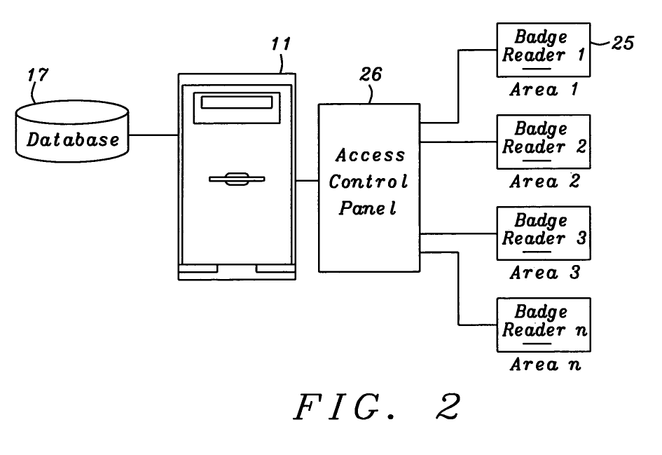

The facility may have several areas (area 1 to area n) which are accessed each by a badge reader 25 as shown in FIG. 2. Each badge reader (badge reader 1 to badge reader n) are coupled to the access control panel 26. Depending upon the authorization stored in the file for the individual 20, the particular badge reader allows or denies access to the particular area of the facility. Employees of a facility, or residents of a property, will have permanent badges, whereas a visitor will have a temporary badge. The badge readers allow individuals to be logged in and out of buildings of a facility and special areas such as vehicular gates and exercise areas. Some authorizations stored in the database file of the individual 20 allow unlimited access to a facility, while authorizations of other individuals may have restrictions that only allow certain areas of the facility to be accessed. When an incident occurs the database is audited to determine what individual had access to a particular area of the facility at the time of the incident. Only the permanent badge (ID card) can be used with the card readers to allow access to be permitted, or denied, and create an automated access record in the database. Access using a key tag and paper badge is limited to that permitted by human guards, who use the system to query the database, determine authorization and create a history record in the database.

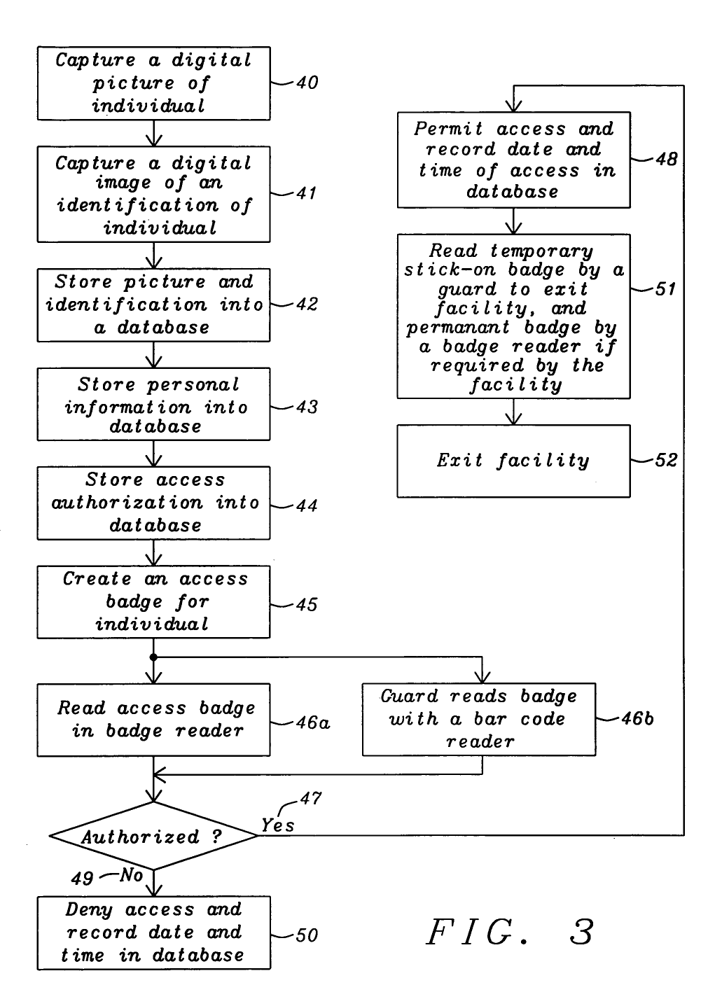

In FIG. 3 is shown a method of the present invention for creating a badge using a digital transaction recorder (related U.S. patent application Ser. No. 10/238,705 filed Sep. 10, 2002) and using the badge to access and exit a facility. A digital picture is captured of an individual 40 by the digital transaction recorder using a first digital camera with flexible positioning. A second digital camera captures a digital image of the identification (ID) of the individual 41. The second digital camera is fixed in position with respect to a holding tray for the identification of the individual. A simple touch of a key on a keyboard attached to the controller of the digital transaction recorder initiates the capture of the digital picture of the individual followed by the capture of the image of the individual's ID. The digital images of the picture of the individual and the individual's ID are stored into the database 42 coupled to the digital transaction recorder. Personal information; comprising one or more of the name, address, telephone number, drivers license number, Social Security number, organization or company affiliation and emergency contact telephone number; are entered into the system using the keyboard attached to the digital transaction recorder and stored in the database file of the individual 43. At a minimum the name of the individual is entered into the database file, or record, of the individual. A badge to access the facility is next created for the individual 45. The badge comprises one or more of the following forms, a key tag with a bar code or magnetic stripe, a permanent badge containing the name and picture of the individual along with a barcode or magnetic stripe for accessing a badge reader, or a temporary stick-on badge with the name and picture of the individual and including the bar code. The key tag is used for frequent visitors to identify information about the visitor in the database to facilitate the creation of the the temporary stick-on badge without the need to re-enter identification information into the database, including the retaking of a photograph of the individual.

Continuing to refer to FIG. 3, The individual uses the badge created by the digital transaction recorder to access the facility by presenting the badge to a badge reader to be read 46a, or to a guard who scans the badge with a bar code reader 46b. A guest with a temporary badge is signed in and out of a facility by the guard scanning the bar code on a temporary badge issued to the guest. If authorization stored in the database file of the individual permits access to an area of the facility 47, the individual is permitted access, and a time and date of the access is recorded into the file of the individual in the database 48. If the computer (controller) is down, the computer will acquire access history form the control panel when the computer is operational again. In normal operation history from automated access is stored in the control panel and periodically downloaded to the controller and database. If the authorization in the database file of the individual does not permit access to a particular area of a facility, access is denied and a date and time is recorded into the database file of the individual 50. When a visitor with a temporary stick-on badge exits the facility, a guard using a bar code scanner scans the stick-on badge, and the date and time are recorded into the data base file of the individual 51. The individual then exits the facility 52 An individual with a permanent badge containing a bar code or a magnetic stripe may also be required to log out of an area of the facility by submitting the permanent badge to a badge reader. This requires a badge reader on the exit side of a gate or door as well as the entrance side.

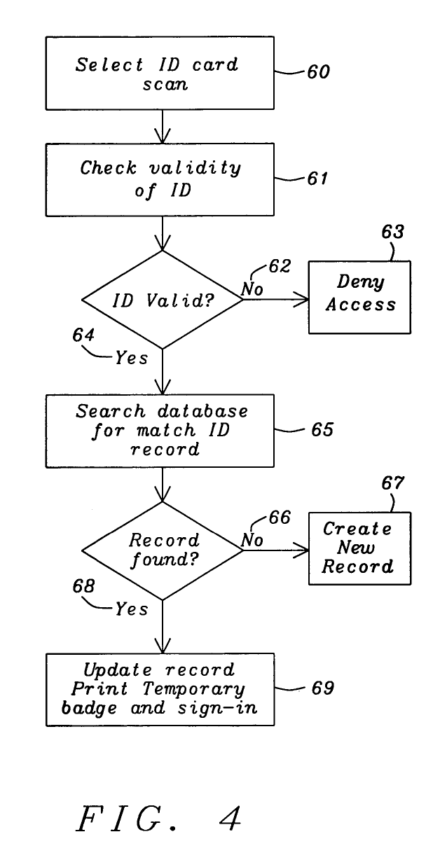

In FIG. 4 is shown a flow diagram of the present invention demonstrating the method of using an identification (ID) scanner to sign in an individual at a facility. When an individual 20 (FIG. 1) enters a facility and requests access, if the digital transaction recorder has an ID scanner attached, the ID card of the individual is scanned 60 using the ID scanner 29 (FIG. 1). The ID scanner scans the bar code or the magnetic stripe contained on the ID, which is usually a government ID card such as a drivers license. The result of the scan is checked for validity 61 and if the ID card is not found valid 62, the individual is denied access to the facility.

If the ID card is found valid, the database of the digital transaction recorder is search for a matching ID record 65. If no record is found 66, a new record is created 67. The new record is formed in part from the information that is obtained from the scan of the ID card, which is used to update personal data fields in a record of the individual that will be stored in the database. As described in FIG. 1 the individual's picture and a picture of the ID are entered into the database along with a copy of any documents being transported by the individual. If a record corresponding to the individual is found in the search of the database 68, the record is updated, a temporary badge is printed and the individual is signed into the facility 69.

While the invention has been particularly shown and described with reference to preferred embodiments thereof, it will be understood by those skilled in the art that various changes in form and details may be made without departing from the spirit and scope of the invention.

1. A facility access control system, comprising:
a) a digital transaction recorder;
b) a database;
c) a badge printer;
d) an access control panel;
e) a badge reader;
f) said digital transaction recorder captures identifying information of an individual and stores said information into said database;
g) said badge printer prints a badge for said individual to permit access to an area of a facility; and
h) said badge reader located at said area reads said identifying information from said badge and couples the identifying information to said access control panel for approval or denial of access to said area.

2. The system of claim 1, wherein said badge printer is a plurality of badge printers to produce a plurality of forms of identification, comprising:
a) a permanent badge read by said badge reader;
b) a key tag read by a guard using a bar code scanner; and
c) a temporary stick-on badge read by said guard using the bar code scanner.

3. The system of claim 1, wherein said digital transaction recorder further comprises:
a) a first camera with flexible positioning to take a picture of said individual;
b) a second camera focused on a holder of said identification document;
c) a scanner to record a document being transported by said individual: and
d) an identification card scanner to verify the validity of the identification card of said individual and to automatically capture information pertaining to said individual for inclusion into a record of said individual in the database.

4. The system of claim 3, wherein said document being transported by said individual is digitized by said scanner and stored into the database.

5. The system of claim 1, wherein said identifying information further comprises:
a) a digital picture of the individual;
b) an identification document;
c) personal information entered from a keyboard of the digital transaction recorder; and
d) an authorization for access to access said area of a facility.

6. The system of claim 1, wherein said database is updated each time said individual enters and leaves said area of the facility by recording time and date.

7. The system of claim 6, wherein said database is searchable using the personal information to provide all occurrences of said individual within said facility.

8. The system of claim 1, wherein said badge has a form comprising:
a) a credit card size permanent badge containing said picture and name of the individual and a scan able media comprising said bar code;
b) a temporary stick-on badge for visitors to the facility containing said picture and name of said individual and said bar code; and
c) a key tag containing a bar code to identify individual to the database to allow the temporary stick-on badge to be printed without re-entry of data into said database.

9. The system of claim 8, wherein said bar code identifies said individual to the access control panel to record events of entry to the facility and to permit access to areas of restricted use if previously authorized.

10. The system of claim 8, wherein said key tag and said temporary stick-on badge are scanned manually by a human guard to permit or deny access to said area of the facility.

11. A method to allow access of an individual to a facility, comprising:
a) capturing a digital image of an individual and said digital image of an identification document of said individual;
b) storing into a database record of said individual:
i) said digital image of said individual,
ii) said digital image of the identification document,
iii) personal information of said individual, and
iv) an access authorization;
c) creating a badge;
d) reading said badge with a badge reader and coupling information read from said badge to an access control panel, and
e) permitting or denying access to an area of said facility by said access control panel.

12. The method of claim 11, wherein creating an access badge further comprises:
a) creating a credit card size permanent badge containing said picture and name of the individual and a scan-able media comprising said bar code or a magnetic stripe;
b) creating a temporary stick-on badge for visitors to the facility containing said picture and name of said individual and said bar code; and
c) creating a key tag containing a bar code to allow said temporary stick-on badge to be created on future visits by said individual without re-entry of identification data into the database

13. The method of claim 11, wherein reading said badge with said badge reader initiates a storing of a date and time of an attempt to access said area into the record of the individual.

14. The method of claim 11, wherein permitting access to the area of the facility is dependent upon said authorization recorded with the individual's record in said database.

15. A control system for permitting access to a facility, comprising:
a) a means for capturing identification of an individual using a digital transaction recorder system,
b) a means for coupling to a database said identification along with personal data and access authorization into a record representing said individual;
c) a means for producing a badge using said digital transaction recorder;
d) a means for reading said badge at an area of a facility; and
e) a means for coupling data read from said badge at said area to an access control panel to obtain access authorization to said area.

16. The system of claim 15, wherein the means for capturing identification of said individual further comprises an identification card scanner to read a coded portion of said identification card.

17. The system of claim 15, wherein said personal data comprises one or more of the following information:
a) name
b) address and telephone number;
c) drivers license number;
d) Social Security number;
e) affiliation; and
f) emergency contact telephone number.

18. The system of claim 15, wherein said access authorization determines which areas of said facility are accessible to said individual.

19. The system of claim 15, wherein said means for producing said badge further comprises:
a) a means for producing a key tag containing a bar code recognizable by a bar code scanner coupled to said database, which identifies said record of the individual in the database;
b) a means for producing a permanent badge containing a picture and name of the individual, a barcode, and/or a magnetic stripe, recognizable by said badge reader, which identifies said record of the individual in the database; and
c) a means for producing a temporary stick-on badge for visitors to the facility containing said picture and name of said individual and said bar code.

20. The system of claim 15, wherein said means for coupling data read from said badge at said area to the access control area to obtain access authorization, stores a date and time of said access to the area into a file, which represents the individual, in the database.
